(19) United States
(12) Patent Application Publication
(10) Pub. No.: US 2018/0111794 A1
(43) Pub. Date: Apr. 26, 2018

(54) Elevator with function of escaping upon failure

(71) Applicant: APXO Elevator Co.,Ltd, Foshan (CN)

(72) Inventors: Weiqiang LU, Foshan (CN); Zuoxi YANG, Foshan (CN)

(73) Assignee: APXO Elevator Co.,Ltd, Foshan (CN)

(21) Appl. No.: 15/524,633

(22) PCT Filed: May 24, 2016
(86) PCT No.: PCT/CN2016/083111

§ 371 Date: May 5, 2017

(51) Int. Cl. B66B 5/02

(52) U.S. Cl. CPC B66B 5/027

(57) ABSTRACT

The present invention relates to an elevator with a function of escaping upon failure. This elevator includes a lift car, a car door, and a variable frequency controller. The lift car is provided with a rescue detecting device. When the elevator malfunctions, whether there is someone being trapped can be detected through the rescue detecting device. If there is someone being trapped, the variable frequency controller can automatically start emergency rescue operation mode, control the lift car to move to the door are, and output instruction of opening the door. The car door drives the landing door to open at the same time such that the trapped person can escape safely.

### CROSS REFERENCE

This application is the national phase of International Application No. PCT/CN2016/083111, filed on May 24, 2016, the entire contents of which are incorporated herein by reference.

### TECHNICAL FIELD

The present invention relates to the technical field of elevators, more particularly, to an elevator having a function of escaping upon failure.

### BACKGROUND

Nowadays, if someone gets trapped in a malfunctioning lift elevator, they have to wait for the professional elevator maintenance staff or special elevator managing personnel to reach the machine room for rescue, which has to be done by two people using a hand winding device to move the lift car of the elevator to the door area and then open the landing door to free the trapped people. In an emergency, the fire brigade may break the elevator to conduct the rescue. However, the existing rescue methods have the following shortcomings. First, the trapped people need to wait for a long time to be rescued and are prone to psychological panic and large psychological stress. Second, since the lift car is not necessarily located in the flat area when the elevator failure occurs, if the trapped people conduct a self-rescue by opening the elevator door, they are very likely to fall in the well and get serious injuries. This causes a great safety risk. For example, when two maintenance personnel conduct a rescue with the winding device, mistakes and unnecessary losses are likely to be caused. In addition, if the rescue is not conducted properly, the equipment of the elevator is likely to be destroyed.

### SUMMARY OF INVENTION

In order to solve the above problems in the prior art, the present invention provides a safe and reliable elevator with a function of escaping upon failure. This elevator can automatically start the rescue operation mode within a short rescue response time.

The technical solution of the present invention is to provide an elevator with a function of escaping upon failure. The elevator comprises a lift car, a car door, and a variable frequency controller. The car door is disposed at an entrance of the lift car. The lift car is provided with a rescue detecting device. The rescue detecting device is connected to the variable frequency controller through signaling. The variable frequency controller is connected to a door opener on the lift car through signaling.

Furthermore, the rescue detecting device includes a human body detecting device disposed on an inner wall of the lift car. The human body detecting device is connected to the variable frequency controller through signaling.

Furthermore, the rescue detecting device further includes two top foreign matter detecting switches and two bottom foreign matter detecting switches. The top foreign matter detecting switches are disposed above the entrance of the lift car, respectively. The bottom foreign matter detecting switches are disposed below the entrance of the lift car, respectively. The top foreign matter detecting switches and the bottom foreign matter detecting switches are connected to the variable frequency controller through signaling.

Furthermore, the rescue detecting device further includes a landing door detecting switch. The landing door detecting switch is disposed above the entrance of the lift car, and the landing door detecting switch is disposed between the top foreign matter detecting switches. The landing door detecting switch is connected to variable frequency controller through signaling.

Furthermore, the door opener is disposed outside the entrance of the lift car. The door opener is connected to the car door through the transmission.

Furthermore, the door opener is provided with a car door full closure detecting switch. The car door full closure detecting switch is connected to the door opener through signaling.

Furthermore, an acousto-optic alarm is provided outside the entrance of the lift car. The acousto-optic alarm is disposed above the door opener. The acousto-optic alarm is connected to the variable frequency controller through signaling.

Furthermore, an inspection switch is disposed on the top of the outside of the lift car. The inspection switch is connected to the variable frequency controller through signaling.

Furthermore, a rescue requesting button is disposed on the inner wall of the lift car. The rescue requesting button is connected to the variable frequency controller through signaling.

Furthermore, a display is disposed on the inner wall of the lift car. The display is connected to the variable frequency controller through signaling.

The beneficial effect of the present invention is as follows. The elevator with a function of escaping upon failure can detect whether someone is trapped in the malfunctioning elevator through the rescue detecting device. If someone is trapped, the variable frequency controller can automatically start the emergency rescue operation mode, control the lift car to move to the door area, and send an instruction of opening the door to the door opener so as to make the car door drive the landing door to open at the same time such that the trapped people can escape safely.

The rescue detecting device can also detect the operation environment. If there is a foreign matter in the moving direction or the landing door which is closest to the moving direction is open, the emergency rescue operation mode is terminated to ensure safety.

When the elevator malfunctions, the trapped person can also start the emergency rescue operation mode through the rescue requesting button. This provides double assurance for starting the emergency rescue operation mode.

When the emergency rescue operation mode starts, the acousto-optic alarm will raise sound and flash warning and send abnormal operation warning to remind the relevant personnel to pay high attention.

When the emergency rescue operation mode starts, the display will play conciliatory voice or video to alleviate the anxiety and tension of the trapped person and reduce the psychological pressure.

### BRIEF DESCRIPTION OF DRAWINGS

FIG. 1 is a structural schematic diagram of the present invention.

In the FIGURES: 1, lift car; 11, door opener; 111, car door full closure detecting switch; 12, acousto-optic alarm; 13, inspection switch; 14, rescue requesting button; 15, display; 2, car door; 3, rescue detecting device; 31, human body detecting device; 32, top foreign matter detecting switch; 33, bottom foreign matter detecting switch; 34, landing door detecting switch.

### DETAILED DESCRIPTION OF INVENTION

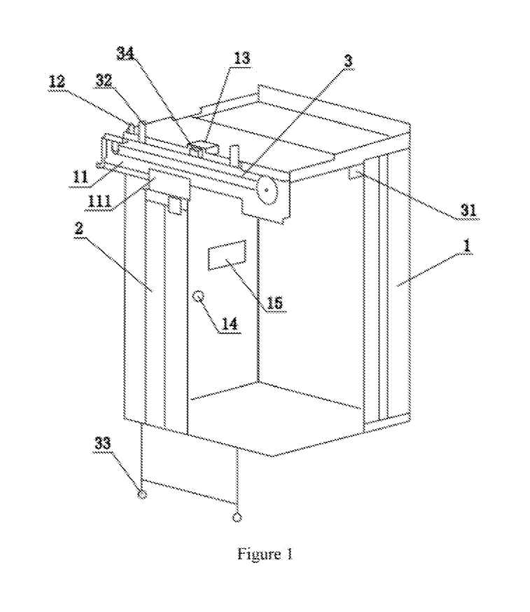

As shown in FIG. 1, the present invention provides an elevator with a function of escaping upon failure. The elevator comprises lift car 1, car door 2, and a variable frequency controller. Car door 2 is disposed at an entrance of lift car 1. Lift car 1 is provided with rescue detecting device 3. Rescue detecting device 3 is connected to the variable frequency controller through signaling. The variable frequency controller is connected to door opener 11 on lift car 1 through signaling. Through rescue detecting device 3, whether there is someone trapped in the malfunctioning elevator can be detected. If someone is trapped, the variable frequency controller can send an instruction of starting the emergency rescue operation mode to door opener 11 and control lift car 1 to move to the door area. Door opener 11 drives car door 2 to open such that the trapped people can escape safely.

Rescue detecting device 3 includes human body detecting device 31 disposed on an inner wall of lift car 1. Human body detecting device 31 is connected to the variable frequency controller through signaling. Through human body detecting device 31, whether there is someone trapped in the malfunctioning elevator can be detected and a feedback signal can be sent to the variable frequency controller. The variable frequency controller determines whether to start the emergency rescue operation mode or not. Rescue detecting device 3 further includes two top foreign matter detecting switches 32 and two bottom foreign matter detecting switches 33. Top foreign matter detecting switches 32 are disposed above the entrance of lift car 1, respectively. Bottom foreign matter detecting switches 33 are disposed below the entrance of lift car 1, respectively. Top foreign matter detecting switches 32 and bottom foreign matter detecting switches 33 are connected to the variable frequency controller through signaling. Both top foreign matter detecting switches 32 and bottom foreign matter detecting switches 33 can detect whether there are foreign matters in the moving direction and send the signal indicating that foreign matters are detected in the moving direction of the variable frequency controller. The variable frequency controller then sends an instruction of terminating the emergency rescue operation mode.

Rescue detecting device 3 further includes landing door detecting switch 34. Landing door detecting switch 34 is disposed above the entrance of lift car 1, and landing door detecting switch 34 is disposed between top foreign matter detecting switches 32. Landing door detecting switch 34 is connected to variable frequency controller through signaling. Landing door detecting switch 33 can detect whether there is an action of opening and closing the landing door in the door area. When the action of opening and closing the landing door is detected, the variable frequency controller sends an instruction of terminating the emergency rescue operation mode. In addition, when landing door detecting switch 33 detects that the landing door closest to the moving direction of lift car 1 is open, the variable frequency controller send an instruction of terminating the emergency rescue operation mode.

Door opener 11 is disposed outside the entrance of lift car 1. Door opener 11 is connected to the variable frequency controller through the transmission. Door opener 11 is connected to car door 2 through signaling. Door opener 11 is provided with car door full closure detecting switch 111. Car door full closure detecting switch 111 is connected to the variable frequency controller through signaling. Car door full closure detecting switch 111 can detect whether car door 2 is fully closed and send signal to door opener 11. When car door 2 is fully closed, door opener 1 send the signal regarding this to the variable frequency controller. In addition, door opener 11 receives the instruction of starting the emergency rescue operation mode from the variable frequency controller and drives car door 2 to open the landing door.

Acousto-optic alarm 12 is provided outside the entrance of lift car 1. Acousto-optic alarm 12 is disposed above door opener 11. Acousto-optic alarm 12 is connected to the variable frequency controller through signaling. Acousto-optic alarm 12 can raise sound and flash warning to remind the relevant personnel to pay high attention in response to the instruction of starting the emergency rescue operation mode sent by the variable frequency controller.

Inspection switch 13 is disposed on the top of the outside of lift car 1. Inspection switch 13 is connected to the variable frequency controller through signaling. Inspection switch 13 sends the signal indicating that the elevator is under maintenance to the variable frequency controller. The variable frequency controller then sends the instruction of terminating the emergency rescue operation mode.

Rescue requesting button 14 is disposed on the inner wall of lift car 1. Rescue requesting button 14 is connected to the variable frequency controller through signaling. The trapped person in the malfunctioning elevator can use rescue requesting button 14 to make the variable frequency controller send the instruction of starting the emergency rescue operation mode.

Display 15 is disposed on the inner wall of lift car 1. Display 15 is connected to the variable frequency controller through signaling. When the variable frequency controller sends the instruction of starting emergency rescue operation mode, display 15 will play conciliatory voice or video to alleviate the anxiety and tension of the trapped person and reduce the psychological pressure.

The present invention is not limited to the preferred embodiments described above. Any person may obtain other various forms of products under the teaching of the present invention. However, no matter how many changes are there in terms of shape or structure, technical solutions that are the same as or similar to that of the present application fall within the scope of the present invention.

What is claimed is:

1. An elevator with a function of escaping upon failure, comprising:
a lift car;
a car door; and
a variable frequency controller;
wherein
the car door is disposed at an entrance of the lift car;
the lift car is provided with a rescue detecting device;
the rescue detecting device is connected to the variable frequency controller through signaling; and
the variable frequency controller is connected to a door opener on the lift car through signaling.

2. The elevator with a function of escaping upon failure according to claim 1, wherein
the rescue detecting device includes a human body detecting device disposed on an inner wall of the lift car; and
the human body detecting device is connected to the variable frequency controller through signaling.

3. The elevator with a function of escaping upon failure according to claim 2, wherein the rescue detecting device further includes
two top foreign matter detecting switches; and
two bottom foreign matter detecting switches;
wherein
the two top foreign matter detecting switches are disposed above the entrance of the lift car;
the two bottom foreign matter detecting switches are disposed below the entrance of the lift car; and
the two top foreign matter detecting switches and the two bottom foreign matter detecting switches are connected to the variable frequency controller through signaling.

4. The elevator with a function of escaping upon failure according to claim 3, wherein
the rescue detecting device further includes a landing door detecting switch;
the landing door detecting switch is disposed above the entrance of the lift car, and the landing door detecting switch is disposed between the two top foreign matter detecting switches; and
the landing door detecting switch is connected to the variable frequency controller through signaling.

5. The elevator with a function of escaping upon failure according to claim 4, wherein
the door opener is disposed outside the entrance of the lift car; and
the door opener is connected to the car door through transmission.

6. The elevator with a function of escaping upon failure according to claim 5, wherein
the door opener is provided with a car door full closure detecting switch; and
the car door full closure detecting switch is connected to the door opener through signaling.

7. The elevator with a function of escaping upon failure according to claim 6, wherein
an acousto-optic alarm is provided outside the entrance of the lift car;
the acousto-optic alarm is disposed above the door opener; and
the acousto-optic alarm is connected to the variable frequency controller through signaling.

8. The elevator with a function of escaping upon failure according to claim 7, wherein
an inspection switch is disposed on the top of the outside of the lift car; and
the inspection switch is connected to the variable frequency controller through signaling.

9. The elevator with a function of escaping upon failure according to claim 8, wherein
a rescue requesting button is disposed on the inner wall of the lift car; and
the rescue requesting button is connected to the variable frequency controller through signaling.

10. The elevator with a function of escaping upon failure according to claim 9, wherein
a display is disposed on the inner wall of the lift car; and
the display is connected to the variable frequency controller through signaling.
